(19) United States
(12) Patent Application Publication
(10) Pub. No.: US 2010/0037165 A1
(43) Pub. Date: Feb. 11, 2010

(54) Transparent Windows

(75) Inventors: Stephen F. Correl, Portland, OR (US); Pradeep Satyanarayana, Portland, OR (US); Debora Velarde, Beaverton, OR (US); Brent W. Yardley, Hillsboro, OR (US)

Correspondence Address: LIEBERMAN & BRANDSDORFER, LLC, 802 STILL CREEK LANE, GAITHERSBURG, MD, 20878, US

(73) Assignee: INTERNATIONAL BUSINESS MACHINES CORPORATION, Armonk, NY (US)

(21) Appl. No.: 12/186,007

(22) Filed: Aug. 5, 2008

(51) Int. Cl. G06F 3/048

(52) U.S. Cl. 715/768

(57) ABSTRACT

A method, apparatus, and article of manufacture are provided to support window transparency on a visual display of a computer system. At least two windows are created and present on the visual display, with each of the windows having transparency attribute. One of the windows is painted with a transparent area, and a second window is painted with a non-transparent area. An attribute is assigned to the transparent area of the window that enables the area to either be anchored to a specified position on the visual display, or free floating or fixed relative to the containing window on the visual display.

### BACKGROUND OF THE INVENTION

1. Technical Field

This invention relates to computer systems and, in particular, to graphical user interfaces. More specifically, the present invention relates to window transparency and properties associated with the transparency.

2. Description of the Prior Art

Most computer systems include multiple types of software for controlling the functions of the computer system. A first type of software is system software, including operating systems, which controls the workings of the computer. A second main type of software is applications, such as word processing programs, spreadsheets, databases, and browsers, which perform the tasks for which people use computers. In addition, a computer system may include network software, which enables groups of computers to communicate, and language software, which provides programmers with the tools they need to write programs.

In computing, a window is an enclosed area on a visual display. Most modern operating systems and applications have graphical user interfaces (GUIs) that allow the visual display to be divided into two or more windows. Each of the windows may accommodate different programs, including execution of different programs in different windows, and display of different data in different windows. Accordingly, employment of multiple windows is particularly valuable in a multitasking environment.

It is known in the art that operating systems provide a graphics card driver for controlling a visual computer environment. The GUI may represent programs, files, and options within graphical images, such as icons, menus, and dialog boxes on an associated visual display. Graphical items defined within the GUI work the same way for the user in most software because the GUI provides standard software routines to handle these elements and report the user's actions. One of the graphical objects defined by a GUI is a window or other defined area of a display containing distinguishable text, graphics, video, audio, and other information for output. A display area may contain multiple windows associated with a single software program or multiple software programs executing concurrently. Graphical user interfaces (GUIs) enable the dimensions and position of each window to be individually set. Windows can be arranged so that they overlap, also known as overlaid windows, or that they do not overlap, also known as tiled windows. In addition to moving windows, changing their size, etc., a window can also be minimized and replaced with an icon. By converting a window into an icon, space on the visual display is freed without erasing the window or terminating the functions of applications within the window. Accordingly, windows are employed on the visual display to support multiple views of two or more tasks in a simultaneous manner.

Often when multiple graphical objects are displayed concurrently, the graphical objects are drawn on top of one another to overlap. The order in which graphical objects are drawn on top of one another on the visual display to simulate depth is typically known as the z-order. Typically, those objects at the top of the z-axis obscure the view of those graphical objects drawn below.

It is known in the art that multiple tasks may execute in parallel. Different tasks require different amounts of time for completion. Furthermore, some executing tasks require monitoring during execution, while other tasks do not require such monitoring. A user may employ multiple windows to manage parallel execution of tasks, with each task executing in its own window. An input device is employed to move between or among the different windows. However, issue arises as to how to monitor an executing task in the underlying window that requires monitoring, while continuing with another task in an overlying window. The visual space of a display is confined to the physical size of the display. One option for management of windows is to cleverly position the windows and size the windows so that monitoring of tasks may be properly managed. However, with the finite amount of space on a visual display, this might not be a viable solution.

It is known in the art to employ a transparency with one or more windows to maximize space on a visual display, and commonly for management of computing tasks. A transparent window adds visual space and visual layers to a display that are unique in a visual context. In the prior art the transparent window may be enlarged or reduced in size, as well as manually dragged from one location on a visual display to another location. More specifically, the prior art addresses transparency of a portion of a window as an innate visual property, wherein the movement and sizing of the window are not inherently associated with transparency.

Therefore, in view of the foregoing, it would be advantageous to provide a method, system, and program for designating a movement property of the transparent portion of a window on the visual display in association with a transparency characteristic that enhances use of the limited space on the associated visual display.

### SUMMARY OF THE INVENTION

This invention comprises a method, system, and article for managing window transparency of a visual display of a computer system.

In one aspect of the invention, a method is provided for managing a transparent window. A first window and a second window are opened on a visual display of a computer system. The first window is separate from the second window. The first and second windows have transparency attributes associated with presentation of data on a visual display. The second window does not have the transparency attribute activated. The first and second windows are painted in accordance with their transparency attributes. The transparency attribute determines the area of transparency of the first window with respect to the second window.

In another aspect of the invention, a computer system is provided with a processor in communication with a visual display, and an application supported by the processor. A first window and a second window are provided on the visual display. The first window and the second windows are separate windows, with the second window overlaid by the first window and viewable on the visual display. The first window has a transparent portion that overlays the second window. A window manager paints the first and second windows in accordance with the transparency attributes of the windows. In addition, an attribute in the window is activated by the window manager to assign a transparency to an area of the first window.

In yet another aspect of the invention, an article is provided with a computer-readable carrier including computer program instructions configured to manage a transparent window. Instructions are provided to open a first window and a second window on a visual display of a computer system. The first is separate from the second window, with the first window having a transparency attribute activated and the second window not having the transparency attribute activated to support presentation of data on the visual display. Instructions are provided to paint the first and second windows. The painting instructions include accounting for the transparency attributes of the first window including determining the area of transparency of the first window with respect to the second window.

In an even further aspect of the invention, a method is provided for managing a transparent window in a computer system. At least two separate windows are opened on a visual display of the computer system. A transparency attribute is assigned to an area of the first window, and not assigned on the second window. The transparent area of the first window is fixed relative to either the visual display or the first window.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention unless otherwise explicitly indicated. Implications to the contrary are otherwise not to be made.

FIG. 1 is a flow chart illustrating assignment of a transparent property to a window of a visual display according to the preferred embodiment of this invention, and is suggested for printing on the first page of the issued patent.

FIG. 2 is a block diagram of a computer system with a window manager and a property tool.

### DESCRIPTION OF THE PREFERRED EMBODIMENT

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Many of the functional units described in this specification have been labeled as managers and attributes. Both the manager(s) and attribute(s) may be implemented in programmable hardware devices such as field programmable gate arrays, programmable array logic, programmable logic devices, or the like. Manager(s) and attribute(s) may also be implemented in software for execution by various types of processors. An identified manager or attribute of executable code may, for instance, comprise one or more physical or logical blocks of computer instructions which may, for instance, be organized as an object, procedure, function, or other construct. Nevertheless, the executables of an identified manager or attribute need not be physically located together, but may comprise disparate instructions stored in different locations which, when joined logically together, comprise the manager(s) or attribute(s) and achieve the stated purpose of the manager(s) or attribute(s).

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

### Overview

The method, apparatus, and article of manufacture of the present invention provides valuable advantage over the prior art. According to the present invention, display properties associated with window transparency for one or more windows on a visual display are configurable to enhance use and operation of a transparent window. A window transparency is designated to direct movement of a transparent window with respect to the visual display and/or a second window. The transparency attribute of a window can also specify the movement of the transparent area with respect to the visual display and/or a second window. This enhances multi-tasking of multiple processes on a visual display with a finite area for display of the windows.

### Technical Details

In the following description of the embodiments, reference is made to the accompanying drawings that form a part hereof, and which shows by way of illustration the specific embodiment in which the invention may be practiced. It is to be understood that other embodiments may be utilized because structural changes may be made without departing form the scope of the present invention.

Transparency is a graphical feature that is particularly advantageous to the present invention when utilizing a characteristic of a window to indicate the status of a computer task. As will be understood by one of ordinary skill in the art, by making a displayable object appear transparent on a window of a computer visual display, other displayable objects are visible through the layer of the transparency. Therefore, by layering windows with respect to the transparency and setting the attributes of the transparent window display, display of information on the limited space of the visual display may be maximized.

In the present invention, a computing task may be interactive or non-interactive. Interactive computing tasks are those performed in direct response to a user input, such as a keystroke, cursor input, etc. Non-interactive computer tasks are those not performed in direct response to a user input. For example, memory and CPU utilization are not typically performed in direct response to a user input, but are utilized by a function of an application operating within the computer system.

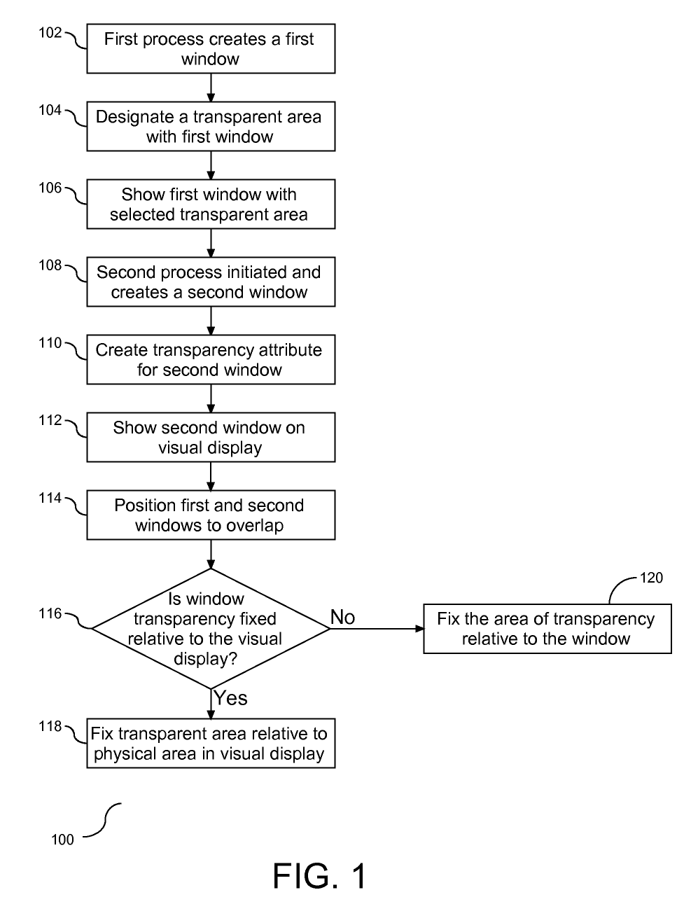

Referring to the drawings, FIG. 1 is a flow chart (100) illustrating a process for managing one or more transparent windows of a computer system. Initially, a first process or program creates a first window (102). The user or program designates a transparent area within this window (104). Painting a window on the visual display encompasses drawing a bit map on the visual display. When the window manager paints the screen on the visual display, the transparent area then becomes visible. To display a bit mapped image on the visual display, the CPU translates the bit map into pixels with color, which may include transparency, assigned to the individual pixels. The first window is shown with the selected transparent area on the associated visual display (106). Sometime after the first process or program starts operating in the first window, a second process or program is initiated and creates a second window (108) with an appropriate transparency attribute for the second window (110). The second window is shown on the associated visual display (112). In one embodiment, more windows may be opened with each window accommodating one program or process. Selection of the transparency attribute for a window as described at steps (104) and (110) defines the color characteristics of the window area, including both transparent and non-transparent attributes thereof. A transparent attribute is a graphical feature pertaining to shading characteristics of a window. In one embodiment, an opaque attribute provides a non-transparent characteristic, whereas a non-opaque attribute provides a transparent characteristic. Accordingly, the attributes selected for the areas of the respective window define the transparent or non-transparent characteristic of the associated window.

The first and second windows are positioned such that the opened windows overlap (114). A window overlap is a condition in which one window is placed over a portion of another window. For purposes of description and in accordance with the example discussed herein, the second window is described to overlap the first window. In one embodiment, the windows may overlap in their entirety or only partially. To enhance viewing of data in association with the window overlap, an area of the second window, i.e. the top layer window, is designated as transparent. It is understood in the art that transparency is a graphical feature that utilizes a shading characteristic of a window. By making a displayable object appear transparent on a visual display, other displayable objects below the displayable objects are visible. Accordingly, by designating all or a portion of window on a visual display as transparent, information on a window beneath the transparency is visible on the visual display.

Once a top layer window or a portion of the top layer window has been designated as transparent, text and graphics in an underlying window becomes visible on an associated visual display. However, in the computing arena, nothing is fixed in space or time. Changes associated with data and the need to view data is dynamic. Following designation of transparency in a top layer window or a portion thereof, an attribute of transparency may be designated, including whether the transparent area should be fixed relative to the visual display, or whether the transparent area should be fixed relative to the window. As shown in FIG. 1, a determination is made as to whether the window transparency should be fixed in position relative to the visual display (116). A positive response to the determination at step (116) fixes the transparent area relative to the physical area designation in the visual display (118). With this determination, the transparent window is fixed and immovable. As a user scrolls up the window containing the designated transparent area, the designated area does not move. The transparency is relative to the visual display, not to the window. A negative response to the determination at step (116) is followed by fixing the area of transparency relative to the window (120). As the window may be moved to a different area of the visual display, or resized, the designated transparent area moves to the new location as the window is moved or resized.

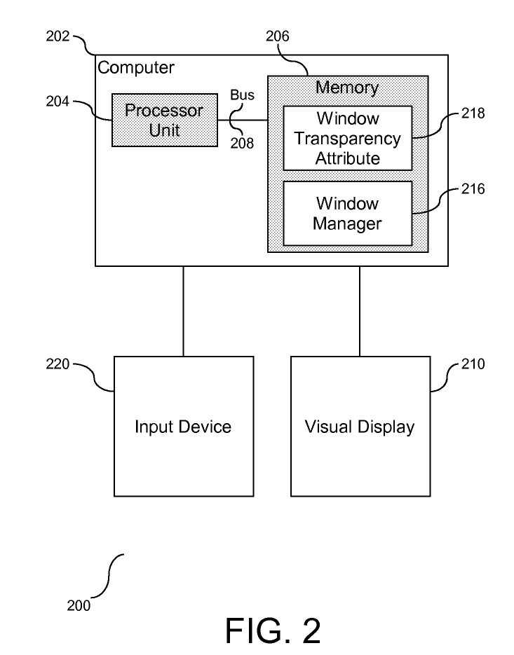

The transparency attribute is used when a window manager paints the screen. FIG. 2 is a block diagram (200) illustrating a window manager in a computer system. The illustration shows a computer system (202) with a processor unit (204) coupled to memory (206) via a bus (208). The computer system (202) is shown in communication with a visual display (210) and an input device (220) to support input of data to the system (202). The invention should not be limited to the quantity of visual displays and input devices shown herein. In one embodiment, the system (202) may include a plurality of visual displays and input devices. Similarly, the computer system (202) should not be limited to a single processing unit (204). In one embodiment, the computer (202) may include two or more processing unit. Accordingly, for illustrative purposes, the following description will be applied to a single computer system (202) with a visual display (210) and input device (220).

The computer system (202) is provided with a window manager (216) embedded within the memory (206). The window manager (216) is a software application used to paint the screen. Each window has a transparency attribute (218) and is used by the window manager to suitably paint the screen (216). In addition, the window has additional attributes that specify whether the transparent area is to be either fixed relative to the visual display (210) or fixed relative to the window in the visual display (210). The window attribute (218) specifies the shape of the transparent area within the window. However, the invention should not be limited to the window manager (216) and window transparency attribute (218) shown herein. In one embodiment, one or more transparent attributes may be assigned to a subject window when a transparent area is selected for the window.

The window managers (216) and the attribute (218) reside in memory (206), as shown, and utilize instructions in a computer readable medium to manage a transparent window of an associated visual display. Similarly, in one embodiment, the manager (216) and attributes (218) may reside as hardware tools external to memory (206), or they may be implemented as a combination of hardware and software in the computer system (202). Accordingly, the manager (216) and attribute (218) may be implemented as a software tool or a hardware tool to facilitate management of a transparent window of a visual display.

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or propagation medium. Examples of a computer-readable medium include but are not limited to a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code includes at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

The software implementation can take the form of a computer program product accessible from a computer-useable or computer-readable medium providing program code for use by or in connection with a computer or any instruction execution system.

### Advantages Over the Prior Art

A transparent area within a window can be fixed relative to the visual display, i.e. anchored with respect to the visual display, or float relative to another window present on the visual display. By fixing a transparent area within a window relative to another window on the visual display, the transparent window moves as the window is moved to a new location on the visual display or as the window is resized. The fixation of the transparency relative to another window enables the transparency to be movable across the area of the visual display. In contrast, by fixing a transparent area within the window relative to the visual display, the transparency is stationary and does not scroll with the window. Accordingly, each window on a visual display that is assigned a transparency attribute may be assigned a secondary attribute that further defines the scope of its movement.

### Alternative Embodiments

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

We claim:

1. A method for managing a transparent window, comprising the steps of:
opening a first window and a second window on a visual display of a computer system, with the first and second windows being separate, the first window having a transparent attribute, and the second window having a non-transparent attribute for supporting presentation of data on the visual display;
painting the first and second windows, including accounting for the transparent attribute of the first window; and
the transparency attribute determining the area of transparency of the first window with respect to the second window.

2. The method of claim 1, further comprising fixing a transparent area within the first window relative to the visual display.

3. The method of claim 1, further comprising fixing a transparent area within the first window relative to the first window.

4. The method of claim 1, further comprising selecting the transparent attribute of the first window.

5. The method of claim 4, further comprising specifying a shape of a transparent area of the first window.

6. The method of claim 4, further comprising automatically applying the transparency attribute when the window is painted by a window manager.

7. A computer system, comprising:
a processor in communication with a visual display;
an application supported by the processor;
a first window, and a separate second window lying underneath the first window and viewable on the visual display, the first window having a transparent area and the second window being non-transparent to support presentation of data on the visual display;
a window manager to paint the first and second windows; and
a transparency attribute used by the window manager to assign a transparency to an area of the first window.

8. The system of claim 7, further comprising the window attribute to fix the transparent area within the first window relative to the visual display.

9. The system of claim 7, further comprising the window attribute to fix the transparent area within the first window relative to the second window.

10. The system of claim 7, further comprising the window attribute to specify a shape of a transparent area of the first window.

11. The system of claim 7, wherein the transparency attribute is applied automatically when the window is painted.

12. An article comprising:
a computer-readable carrier including computer program instructions configured to manage a transparent window, the instructions comprising:
instructions to open a first window and a second window on a visual display of a computer system, with the first and second windows being separate, the first window having a transparent area, and the second window having a non-transparent area to support presentation of data on the visual display;
instructions to paint the first and second windows, including accounting for the transparent attribute of the first window; and
instructions to determine the area of transparency of the first window with respect to the second window.

13. The article of claim 12, further comprising instructions to fix a transparent area within the first window relative to the visual display.

14. The article of claim 12, further comprising instructions to fix a transparent area within the first window relative to the first window.

15. The article of claim 12, further comprising instructions to specify the transparent attribute of the first window with the aid of a window manager.

16. The article of claim 15, further comprising instructions to specify a shape of a transparent area of the first window with a window attribute.

17. The article of claim 12, further comprising instructions to automatically apply the transparent attribute when the window is painted.

18. A method for managing a transparent window, comprising the steps of:
opening at least two separate windows on a visual display of a computer system;
assigning a transparent attribute to an area of the first window, and assigning a non-transparent attribute to an area of the second window; and
fixing the transparent area of the first window relative to an element selected from the group consisting of: the visual display and the first window.
